(19) United States
(12) Patent Application Publication
(10) Pub. No.: US 2015/0118981 A1
(43) Pub. Date: Apr. 30, 2015

(54) INTERNAL FEEDBACK RECEIVER BASED VSWR MEASUREMENT

(71) Applicant: QUALCOMM Incorporated, San Diego, CA (US)

(72) Inventors: Li GAO, San Diego, CA (US); Chalin C. LEE, San Diego, CA (US); Wesley SAMPSON, San Diego, CA (US); Abhishek AGRAWAL, Fremont, CA (US); Douglas GROVER, San Diego, CA (US); Rema VAIDYANATHAN, San Diego, CA (US); Jarir FADLULLAH, San Diego, CA (US); Dongbo ZHANG, San Diego, CA (US); Amit SHAH, Santa Clara, CA (US); Ajay IYER, Santa Clara, CA (US)

(73) Assignee: QUALCOMM Incorporated, San Diego, CA (US)

(21) Appl. No.: 14/261,355

(22) Filed: Apr. 24, 2014

Related U.S. Application Data
(60) Provisional application No. 61/897,807, filed on Oct. 30, 2013.

(51) Int. Cl. H04B 17/00

(52) U.S. Cl. CPC H04B 17/0027
USPC 455/115.1

(57) ABSTRACT

A method and apparatus of internal measurement of voltage standing wave ratio in a transmitter includes providing power to hardware comprising the transmitter, transmitting a signal from the transmitter, sampling the signal in both a transmitted feedforward direction toward an antenna and a reflected direction from the antenna, and computing in a processor associated with the transmitter the voltage standing wave ratio on the basis of the feedforward and reflected sampled signals. A method of calculating a voltage standing wave ratio (VSWR) in a transmitter includes storing, in a memory associated with a processor associated with the transmitter, a captured feedforward signal from the transmitter to an antenna, storing, in the memory, a captured feedback signal reflected from the antenna, and calculating the VSWR in the processor on the basis of the stored transmitted and reflected signals.

### CROSS-REFERENCE TO RELATED APPLICATION

This application claims the benefit of U.S. Provisional Application Ser. No. 61/897,807, filed on Oct. 30, 2013, which is expressly incorporated by reference herein in its entirety.

### FIELD

The present disclosure relates generally to wireless communication systems, and more particularly to factory production or online internal monitoring of transmitter antenna voltage standing wave ratio (VSWR).

### BACKGROUND

Wireless communication devices have become smaller and more powerful as well as more capable. Increasingly users rely on wireless communication devices for mobile phone use as well as email and Internet access. At the same time, devices have become smaller in size. Devices such as cellular telephones, personal digital assistants (PDAs), laptop computers, and other similar devices provide reliable service with expanded coverage areas. Such devices may be referred to as mobile stations, stations, access terminals, user terminals, subscriber units, user equipments, and similar terms.

A wireless communication system may support communication for multiple wireless communication devices at the same time. In use, a wireless communication device may communicate with one or more base stations by transmissions on the uplink and downlink. Base stations may be referred to as access points, Node Bs, or other similar terms. The uplink or reverse link refers to the communication link from the wireless communication device to the base station, while the downlink or forward link refers to the communication from the base station to the wireless communication devices.

Wireless communication systems may be multiple access systems capable of supporting communication with multiple users by sharing the available system resources, such as bandwidth and transmit power. Examples of such multiple access systems include code division multiple access (CDMA) systems, time division multiple access (TDMA) systems, frequency division multiple access (FDMA) systems, wideband code division multiple access (WCDMA) systems, global system for mobile (GSM) communication systems, enhanced data rates for GSM evolution (EDGE) systems, and orthogonal frequency division multiple access (OFDMA) systems.

At the antenna of a mobile communication device, impedance matching between a transmitter channel power amplifier (PA) and the antenna may change over frequency due to various effects, such as, hand capacitance. The voltage standing wave ratio (VSWR) of transmitted signal reflected internally from the antenna may change and could impact PA performance, with consequent deterioration of the transmit signal quality.

In general, testing, including VSWR testing, takes place in the factory and requires expensive test equipment or equipment options such as network analyzer. The current test philosophy of connecting to factory automated test equipment (ATE) may be inefficient and not conducive to pipeline testing.

Transmit signal quality generally degrades when VSWR degrades. Existing transmitter solution requires large transmit signal performance margin to allow tolerance of transmit signal quality degradation over VSWR. Large transmit signal performance margin usually generally reduce transmit power efficiency. In view of at least the above, a need exists for a system and/or methodology to measure/monitor VSWR of a transmit chain internally through feedback receiver sampling using internal self-testing which may reduce overhead in factory production testing and enable dynamic control of VSWR, or dynamic update of transmitter according to VSWR measurement.

### SUMMARY

The following presents a simplified summary of the disclosed aspects in order to provide a basic understanding of such aspects. This summary is not an extensive overview of all contemplated aspects, and is intended to neither identify key or critical elements nor delineate the scope of such aspects. Its sole purpose is to present some concepts of the disclosed aspects in a simplified form as a prelude to the more detailed description that is presented later.

To the accomplishment of the foregoing and related ends, one or more aspects include the features hereinafter fully described and particularly pointed out in the claims. The following description and the annexed drawings set forth in detail certain illustrative aspects of the disclosed aspects. These aspects are indicative, however, of merely a few of the various ways in which the principles of various aspects may be employed. Further, the disclosed aspects are intended to include all such aspects and their equivalents.

### BRIEF DESCRIPTION OF THE DRAWINGS

FIG. 1 illustrates a wireless multiple-access communication system in accordance with various aspects set forth herein.

FIG. 2A is a block diagram of a wireless transmitter system equipped for internal measurement and monitoring of VSWR in accordance with the disclosure.

FIG. 2B is a block diagram of a portion of the wireless transmitter system of FIG. 2A, in accordance with the disclosure.

FIGS. 3A, 3B, and 3C illustrate a representative set of waveforms obtained by the internal measurement and monitoring apparatus of FIG. 2 in accordance with the disclosure.

FIG. 4 is an embodiment of a method of calculating VSWR based on the acquired waveforms of FIGS. 3A, 3B, and 3C in accordance with the disclosure.

FIG. 5 is an exemplary flow diagram of a method of self-test to determine VSWR in a transmitter in accordance with the disclosure.

### DETAILED DESCRIPTION

Various aspects are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

As used in this application, the terms “component,” “module,” “system,” and the like are intended to refer to a computer-related entity, either hardware, firmware, a combination of hardware and software, software, or software in execution. For example, a component may be, but is not limited to being, a process running on a processor, an integrated circuit, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network, such as the Internet, with other systems by way of the signal).

Furthermore, various aspects are described herein in connection with an access terminal and/or an access point. An access terminal may refer to a device providing voice and/or data connectivity to a user. An access wireless terminal may be connected to a computing device such as a laptop computer or desktop computer, or it may be a self-contained device such as a cellular telephone. An access terminal can also be called a system, a subscriber unit, a subscriber station, mobile station, mobile, remote station, remote terminal, a wireless access point, wireless terminal, user terminal, user agent, user device, or user equipment. A wireless terminal may be a subscriber station, wireless device, cellular telephone, PCS telephone, cordless telephone, a Session Initiation Protocol (SIP) phone, a wireless local loop (WLL) station, a personal digital assistant (PDA), a handheld device having wireless connection capability, or other processing device connected to a wireless modem. An access point, otherwise referred to as a base station or base station controller (BSC), may refer to a device in an access network that communicates over the air-interface, through one or more sectors, with wireless terminals. The access point may act as a router between the wireless terminal and the rest of the access network, which may include an Internet Protocol (IP) network, by converting received air-interface frames to IP packets. The access point also coordinates management of attributes for the air interface.

Moreover, various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ), and integrated circuits such as read-only memories, programmable read-only memories, and electrically erasable programmable read-only memories.

Various aspects will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

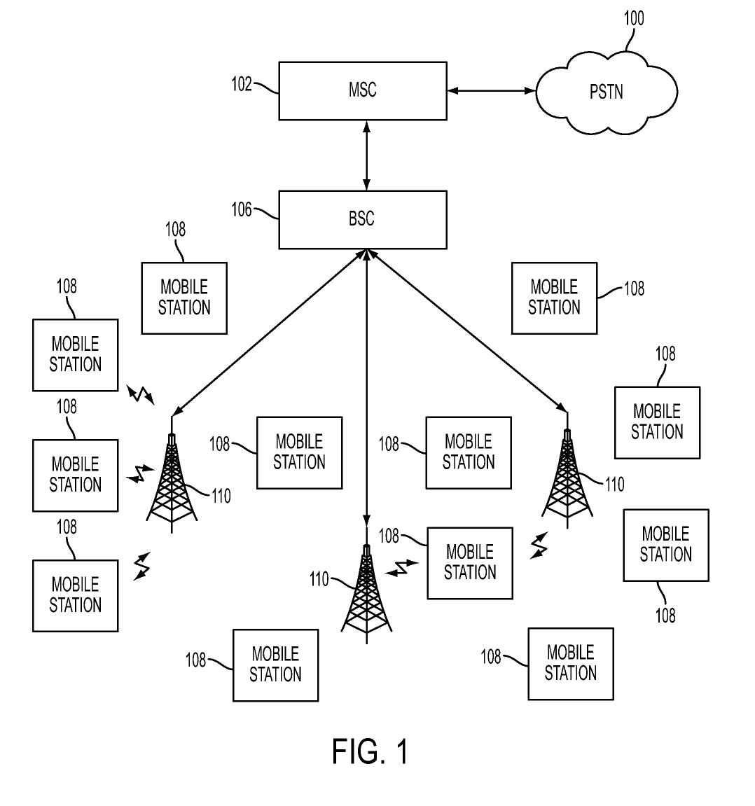

FIG. 1 illustrates a wireless system that may include a plurality of mobile stations 108, a plurality of base stations 110, a base station controller (BSC) 106, and a mobile switching center (MSC) 102. The system 100 may be GSM, EDGE, WCDMA, CDMA, etc. The MSC 102 may be configured to interface with a public switched telephone network (PTSN) 104. The MSC may also be configured to interface with the BSC 306. There may be more than one BSC 106 in the system 300. Each base station 110 may include at least one sector, where each sector may have an omnidirectional antenna or an antenna pointed in a particular direction radially away from the base stations 110. Alternatively, each sector may include two antennas for diversity reception. Each base station 110 may be designed to support a plurality of frequency assignments. The intersection of a sector and a frequency assignment may be referred to as a channel. The mobile stations 108 may include cellular or portable communication system (PCS) telephones.

During operation of the cellular telephone system, the base stations 110 may receive sets of reverse link signals from sets of mobile stations 108. The mobile stations 108 may be involved in telephone calls or other communications. Each reverse link signal received by a given base station 110 may be processed within that base station 110. The resulting data may be forwarded to the BSC 106. The BSC 106 may provide call resource allocation and mobility management functionality including the orchestration of soft handoffs between base stations 110. The BSC 106 may also route the received data to the MSC 102, which provides additional routing services for interfacing with the PSTN 104. Similarly, the PTSN 104 may interface with the MSC 102, and the MSC 102 may interface with the BSC 106, which in turn may control the base stations 110 to transmit sets of forward link signals to sets of mobile stations 108.

VSWR has traditionally been measured using a network analyzer, which is very expensive equipment, and typically limited to a factory testing environment. However, in online operation VSWR may have a big variable impact of transmit signal quality, especially in a nonlinear PA with predistortion.

Concerning self-testing of TX transmission VSWR from mobile devices, disclosed in an aspect of a first embodiment is an apparatus enabled for VSWR measurement/monitor through capture of a transmit signal by a feedback receiver, wherein there is no need for network analyzer. In an aspect of the embodiment, a front end switch enables the capture of both forward and reflected signal. The Tx signal may be captured as a reference, the amplitude and phase of both feedforward and feedback signal may be calculated, from which the VSWR may be calculated.

In another aspect of the disclosure, self-test VSWR measurement is done through feedback receiver sampling capture. Software/firmware algorithm processing operates without need for a network analyzer. This may enable online VSWR monitoring, which could help to guide control of the transmitter to accommodate dynamic changes in VSWR or adjust analog component to align VSWR to target settings, and eventually improve and/or maintain transmit quality.

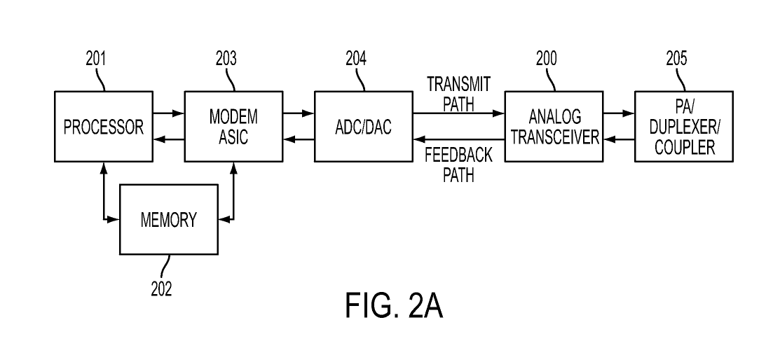

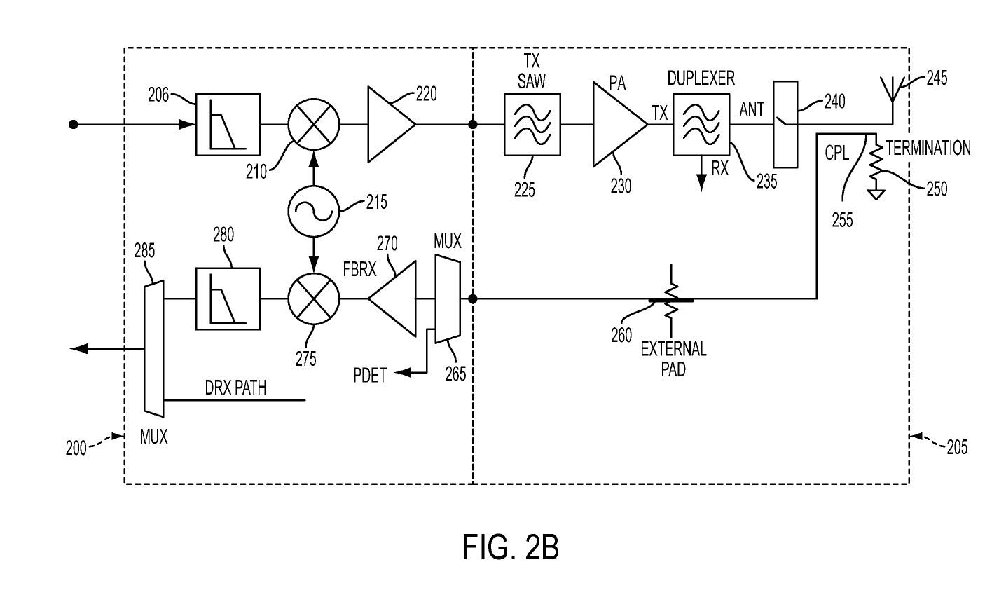

FIG. 2A is a block illustration of a transceiver system including an internal self-testing VSWR measurement apparatus which may, for example, exist as part of a mobile communications device, but is not so limited, and may be applied in other transmitting systems. An analog transceiver 200 includes features that will be described in more detail below. A processor 201 may be coupled to a memory 202 and to a modem 203, which may be an application specific integrated circuit (ASIC) chip. Two-way communication of data is possible between the processor 201 and memory 202, between the processor 201 and the modem 203, and between the memory 202 and the modem 203.

The modem 203 communicates digital data to an ADC/DAC module 204 (which may be a separate chip or included as a component of the modem 203) where the digital data is converted to an analog signal by an digital-to-analog converter (DAC). Analog data received by the ADC/DAC module 204 is converted to digital data by an analog-to-digital converter (ADC) for communication to the modem 203. The ADC/DAC module 204 transmits analog data to, and receives analog feedback data from the analog transceiver 200, which may be a separate ASIC chip or series of components. The analog transceiver 200 communicates (bi-directionally) with a signal management module 205 including at least a power amplifier, duplexer coupler and antenna, which will be described in more detail below.

Referring to FIG. 2B, the RF ASIC 200 includes hardware provisioning for self-test of TX/RX signals. The self-test hardware includes a low pass filter 206 that receives the analog signal from the ADC/DAC module 204. An oscillator 215 provides a carrier frequency, and a mixer 210 combines the analog signal and carrier to up-convert the analog signal to an RF carrier modulated transmission waveform. The transmission carrier waveform may be determined by one of of several transmission mode technologies (e.g., GSM, EDGE, WCDMA, CDMA, etc.) that may be used. An amplifier 220 may amplify the modulated signal, which then exits the RF ASIC 200, and enters the signal management module 205, where it is then filtered at the carrier frequency band by, for example, a TX surface acoustic wave (TX SAW) pass band filter 225, or a filter based on another technology. In some embodiments, a pass band filter may not be used.

A power amplifier (PA) 230 provides gain of the signal filtered by the TX SAW filter 225 to a transmission level power. (In some platforms, a filter 225 may not be needed). The amplified TX signal passes through a duplexer 235. The duplexer 235 passes the amplified TX signal for transmission to an antenna 245, and receives an RX signal from the antenna 245. A switch 240 between the duplexer 235 and the antenna 245 may control transmission from the TX portion and reception of an RX signal received by the antenna 245 for communication to the RX portion of the analog transceiver 200.

To conduct a self-test, a reconfigurable coupler 255 taps a portion of the transmitted signal passed from the switch 240 to the antenna 245. The coupler 255 may be biased at a voltage relative to ground by a termination resistor 250. A directional switch in the coupler 255 controls, by reconfiguration, whether the feed forward signal or reflection signal is fed to a feedback receiver.

An attenuator 260, which may be programmable, adjusts the tapped power level for detection and processing by a section of the analog transceiver 200, i.e., the RX portion dedicated to the transmission power self-test. The attenuated portion of the tapped transmission signal is input to a demultiplexer MUX 265 in the analog transceiver 200, which may select the attenuated portion of the tapped transmission signal for amplification by an amplifier 270.

The detected tapped transmission signal may be mixed with the carrier frequency (supplied from the oscillator 215) in a mixer 275 and filtered by a low pass filter 280 to provide a down converted signal to baseband corresponding to the digital signal input to the low pass filter 206 for the original transmission. The filtered base band signal is then converted into digital sample by the analog-to-digital converter (ADC) in the ADC/DAC module 204 for calculation of the transmitted VSWR in the processor 201.

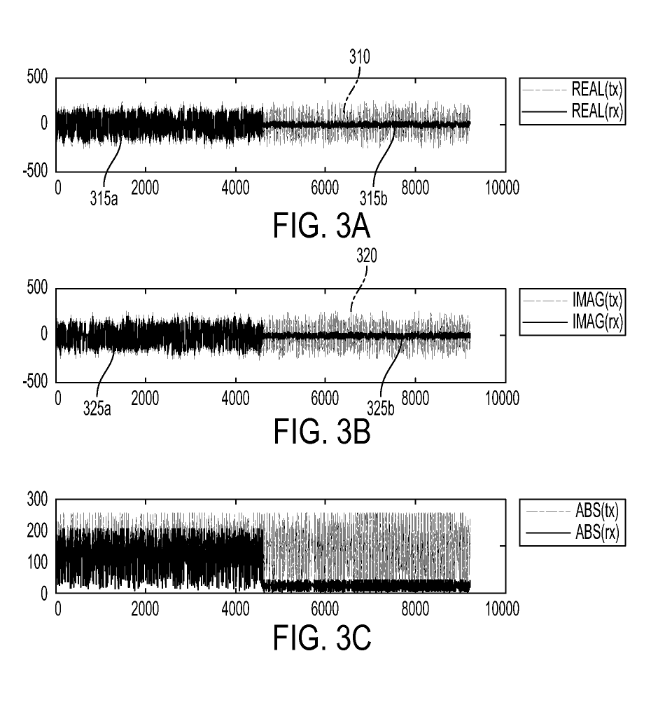

A method of measuring VSWR is based on a principle of capturing two sets of feedback and simultaneously detecting forward coupling (to measure the transmitted signal, which may be described by an amplitude and phase) and reverse coupling (to measure the reflected signal, also described by a corresponding amplitude and phase, which may also be expressed as real and imaginary components, i.e., having a 90° phase difference). This is enabled, referring to FIG. 3, by capturing the two feed-back signals using 2 different coupler configurations during a single waveform capture, which may be enabled by the reconfigurable directional switch RF coupler 255. Referring to FIGS. 3A and 3B, a Tx signal (real 310, imaginary 320) is continuously captured. During the single trigger capture, as shown in the middle of the displayed captured waveform, the RF switch 255 may be reconfigured such that a first section of Rx signal (real 315a, imaginary 325a) captured is a feed forward signal, and the second portion of the Rx signal (real 315b, imaginary 325b) captured is a reflection signal. This enables capture of the reflected signal Rx while maintaining phase coherence with the transmitted wave. For reference, the absolute value (sqrt[|real|²+[|imaginary|²]) of the feedforward and reflection signal are shown in FIG. 3C.

If, instead, separate feed forward and reflection waveforms are captured, special attention may be paid in the feedback receiver to maintain a coherent phase relationship. Otherwise, the only information available is amplitude, from which power may be calculated; however, VSWR phase may not be determined.

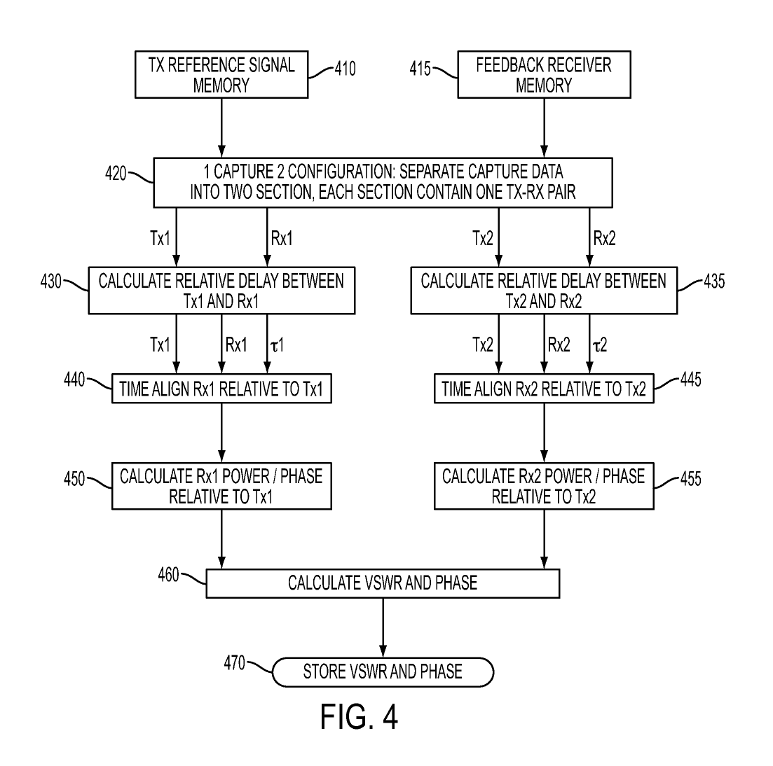

FIG. 4 is a flow chart of an embodiment of a method to calculate VSWR and phase from acquired sampled waveforms, such as shown in FIGS. 3A, 3B and 3C.

The method begins with storing a transmit signal sample (process block 410) and storing a feedback receiver signal (process block 415) in memory 202. In each case the waveform is sampled and captured continuously (Process block 420). However, part-way through a capture sampling the RF switch is reconfigured to capture the reflection signal. Because the transmitted signal is established by a phase locked loop, the phase coherency of the transmitted and reflected waves remain intact, so that the phase difference is meaningful and not arbitrary. Thus, the step is referred to as “1 capture/2 configuration.” Captured data is comprises real and imaginary components of data. Each data section contains one TX-RX pair, i.e., the first data section contains the transmitted signal 310, 320 for the switch 255 in one configuration, and the second data section contains the reflected signal 315, 325.

During operation, the switch 255 is first configured such that feedback receiver captures the incident (transmission, or feed forward) waveform. The signal Tx₁ and feedback receiver signal Rx₁ captured are fractionally aligned, i.e., the amplitude and phase of each signal are compared to calculate relative amplitude/phase between Rx₁ and Tx₁ as an amplitude A₁, time delay τ1 and phase φ₁ (process block 430). The feed forward signal may be represented as V_{f}=A₁*exp(jφ₁), and is stored in a reference memory log. The relative delay τ1 between Tx₁ and Rx₁ is calculated (process block 430) and Rx₁ is time aligned relative to Tx₁ (process block 440).

In a corresponding manner, with the switch configured such that feedback receiver captures the reflection waveform, the captured signal Tx₂ and feedback receiver captured signal Rx₂ are fractionally aligned, i.e., the amplitude and phase of each signal are compared to calculate relative amplitude/phase between Rx₂ and Tx₂ as an amplitude A₂, time delay and phase φ₂ (process block 435). The reflection signal may be represented as Vᵣ=A₂*exp(jφ₂), and is stored in a feedback receiver memory. Rx₂ is time aligned relative to Tx₂. The relative delay τ2 between Tx₂ and Rx₂ is calculated (process block 435) and Rx₂ is time aligned relative to Tx₂ (process block 445).

The power of Rx₁ relative to Tx₁ (calculated in process bloc 450) may be defined as |V_{f}|², and the power of Rx₂ relative to Tx₂ (calculated in process bloc 455) may be defined as |Vᵣ|². The reflection coefficients may be defined as

$$Γ = \frac{{V}_{r}}{{V}_{f}} = \frac{{A}_{2} {exp}^{j {ϕ}_{2}}}{{A}_{2} {exp}^{j {ϕ}_{1}}} = \frac{{A}_{2}}{{A}_{1}} * {exp}^{j ( {ϕ}_{2} - {ϕ}_{1} )}$$

VSWR is calculated (in process block 460) as

$$VSWR = \frac{1 + \vert Γ \vert}{1 - \vert Γ \vert} = \frac{1 + \frac{{A}_{2}}{{A}_{1}}}{1 - \frac{{A}_{2}}{{A}_{1}}} = \frac{{A}_{1} + {A}_{2}}{{A}_{1} - {A}_{2}}$$

and front-end phase matching is calculated as φ=φ₂−φ₁.

The VSWR and phase cp may then be stored in memory (process block 470), available to implement improved phase matching for improved VSWR.

“One-capture/two-configuration” is set up for the purpose of conserving phase difference coherency between the transmitted and reflected signal to calculate phase match. In an embodiment where we are only interested in VSWR without phase, two independent captures could be conducted. Firmware/software processing of sample capture in two independent captures can only extract amplitude information, but phase information is lost.

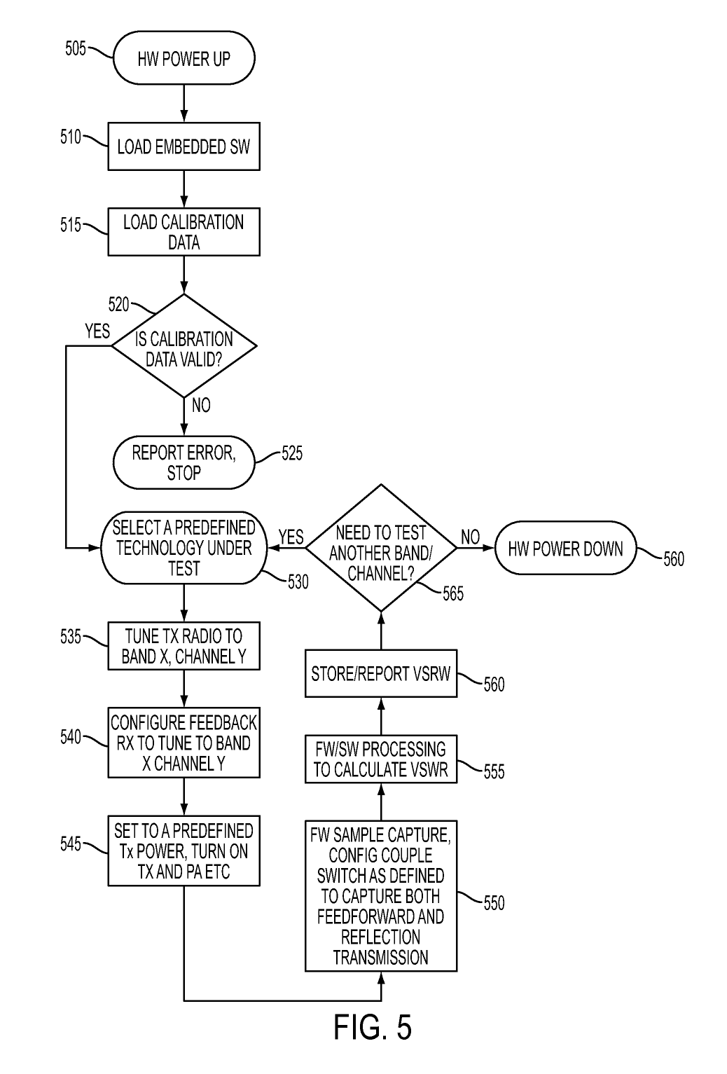

FIG. 5 illustrates an embodiment of a method process flow of TX self-test internal measurement of VSWR. The mobile device (e.g., radio) may be configured to any of several wireless wide area network technologies in which testing is to be conducted. This may include, for example, be Long Term Evolution (LTE), Wideband Code Division Multiple Access (WCDMA), Code Division Multiple Access (CDMA), Time Division Synchronous Code Division Multiple Access (TDS-CDMA), or any comparable transmission encoding techniques.

In an embodiment of the method, the self-testing elements of the transmitter system hardware are powered up (process block 505). Next, software (SW) may be downloaded for embedment in the processor 201 of the transmitter hardware (process block 510). This step may be performed at the assembly/manufacture stage or, alternatively, during testing, in which case the SW may be download from a remote server to the transmitter hardware. Calibration data may then be downloaded to the transmitter hardware (process block 515). Again, this step may be performed at the assembly/manufacture stage or, alternatively) during testing, in which case the transmitter hardware may download the data from a remote server.

Then, a determination is made of whether the calibration data is valid (process block 520). If the calibration data is not valid an error report is issued (process block 525) and the test procedure stops. If the calibration data is valid, the self-test continues (process block 530), where the technology to be tested (e.g., LTE, WCDMA, CDMA, TDS-CDMA, etc.) is selected.

Next, the transmitter hardware may be tuned to a band and channel under test, for example, band X, channel Y (process block 535). This tuning step may include calculating the band center frequency for the TX phase locked loop (PLL), tuning the oscillator 215 PLL to the correct frequency, applying any normal pre-processing to the TX signal, including pre-distortion, etc.

The method may then configure a feedback RX (FBRX) path tuned to the band X, channel Y under test (process block 540). This tuning step may include calculating the band center frequency for the FBRX PLL, tuning the FBRX to the correct frequency, configuring the modem RX chain to receive the FBRX demodulated RF signal. The FBRX path may be reside, in a first embodiment, on the same RF ASIC chip as the TX or, in a second embodiment, it may be a separate RX path residing on another RF ASIC chip or a discrete RX path.

This step may also includes configuration of analog-to-digital conversion (ADC) to convert the analog signal from the FBRX path to a digital format to be processed digitally by a modem RX chain (not shown). This also may include configuring the modem RX path to process the current WWAN technology under test and configure the modem RX path to take analog input from the FBRX path.

The next step (process block 545) may include setting a desired TX power to transmit at a predetermined power under test. The TX path may be turned on to power up and configure power amplifiers (PAs).

Next, to capture forward transmitted and reflected waveforms, the coupler switch is configured (process block 550) to capture both feed forward and reflection transmission signal samples.

In the next step, the samples (captured in firmware) are processed in software to calculate VSWR and phase (process block 555). In a following step the value of VSWR and phase are stored and a report may be generated (process block 560).

A decision is made whether to test another band and/or channel (process block 565). If so, the method continues process block 535 to select another predefined technology for which VSWR determination is to be made. If not, the hardware is powered down and the VSWR determination test is complete (process block 570).

It is to be understood that the aspects described herein may be implemented in hardware, software, firmware, middleware, microcode, or any combination thereof. When the systems and/or methods are implemented in software, firmware, middleware or microcode, program code or code segments, they may be stored in a machine-readable medium, such as a storage component. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, etc.

For a software implementation, the techniques described herein may be implemented with modules (e.g., procedures, functions, and so on) that perform the functions described herein. The software codes may be stored in memory units and executed by processors. The memory unit may be implemented within the processor or external to the processor, in which case it can be communicatively coupled to the processor via various means as is known in the art.

What has been described above includes examples of one or more aspects. It is, of course, not possible to describe every conceivable combination of components or methodologies for purposes of describing the aforementioned aspects, but one of ordinary skill in the art may recognize that many further combinations and permutations of various aspects are possible. Accordingly, the described aspects are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description or the claims is meant to be a “non-exclusive or.”

What is claimed is:

1. A method of internal measurement of voltage standing wave ratio in a transmitter comprising:
providing power to hardware comprising the transmitter;
transmitting a signal from the transmitter;
sampling the signal in both a transmitted feedforward direction toward an antenna and a reflected direction from the antenna; and
computing in a processor associated with the transmitter the voltage standing wave ratio on the basis of the feedforward and reflected sampled signals.

2. The method of claim 1, further comprising:
before transmitting the signal, loading software to a memory associated with the processor;
loading calibration data to the processor memory;
determining if the calibration data is valid; and
if the calibration data is valid, selecting a predefined transmission mode for testing.

3. The method of claim 2 further comprising:
if the calibration data is not valid, issuing an error report; and
ending the measurement.

4. The method of claim 2 further comprising:
if the calibration data is valid, selecting a predefined transmission mode technology to be tested;
tuning the transmitter to a band X and a channel Y; and
configuring a receiver to be tuned to the band X and the channel Y.

5. The method of claim 4 further comprising turning on the transmitter to a predefined power.

6. The method of claim 5, wherein turning on the transmitter comprises powering a power amplifier associated with the transmitter.

7. The method of claim 1 further comprising storing a report of the VSWR in the memory.

8. The method of claim 7 further comprising issuing from the processor a report of the VSWR.

9. The method of claim 1, further comprising determining if another band and/or channel is to be tested.

10. The method of claim 9, further comprising:
if another band and/or channel is to be tested, selecting a predefined transmission mode technology to be tested;
repeating the measurement of voltage standing wave ratio in the transmitter; and
if no further tests are to be made, powering down the hardware comprising the transmitter.

11. A method of calculating a voltage standing wave ratio (VSWR) in a transmitter comprising:
storing, in a memory associated with a processor associated with the transmitter, a captured feedforward signal from the transmitter to an antenna;
storing, in the memory, a captured feedback signal reflected from the antenna; and
calculating the VSWR in the processor on the basis of the stored transmitted and reflected signals.

12. The method of claim 11, wherein capturing the feedforward and feedback signal comprises:
continuously capturing an input signal via a directional coupler comprising a directional switch, wherein the directional switch is configured for the coupler to receive the transmitted feedforward signal during a first portion of the input to the directional coupler, and wherein the directional switch is configured for the coupler to receive the reflected feedback signal during a second portion of the input to the directional coupler.

13. The method of claim 12, wherein calculating the voltage standing wave ratio further comprises:
calculating an amplitude of the respective transmitted and reflected signals captured in the first portion of the input to the directional coupler;
calculating a first relative delay between the respective transmitted and reflected signals captured in the first portion;
calculating an amplitude of the respective transmitted and reflected signals captured in the second portion of the input to the directional coupler;
calculating a first relative delay between the respective transmitted and reflected signals captured in the second portion;
aligning the time of the reflected signal captured in the first portion relative to the transmitted signal captured in the first portion; and
aligning the time of the reflected signal captured in the second portion relative to the transmitted signal captured in the second portion.

14. The method of claim 13, wherein calculating (VSWR) comprises:
calculating a power and phase of the reflected signal in the first portion relative to the transmitted signal in the first portion;
calculating a power and phase of the reflected signal in the second portion relative to the transmitted signal in the second portion;
calculating a reflection coefficient on the basis of the reflected power in the second portion and the transmitted power in the first portion; and
calculating the VSWR and phase between the on the basis of an absolute value of the reflection coefficient.

15. The method of claim 13, further comprising storing the VSWR and phase in the memory.

16. A non-transitory computer readable media including program instructions which when executed by a processor cause the processor to perform a method of calculating a voltage standing wave ratio (VSWR) in a transmitter comprising the steps of:
storing, in a memory associated with a processor associated with the transmitter, a captured feedforward signal from the transmitter to an antenna;
storing, in the memory, a captured feedback signal reflected from the antenna; and
calculating the VSWR in the processor on the basis of the stored transmitted and reflected signals.

17. The non-transitory computer readable media including the program instructions of claim 16, wherein capturing the feedforward and feedback signal comprises:
continuously capturing an input signal via a directional coupler comprising a directional switch, wherein the directional switch is configured for the coupler to receive the transmitted feedforward signal during a first portion of the input to the directional coupler, and wherein the directional switch is configured for the coupler to receive the reflected feedback signal during a second portion of the input to the directional coupler.

18. The non-transitory computer readable media including the program instructions of claim 16, wherein calculating the voltage standing wave ratio further comprises:
calculating an amplitude of the respective transmitted and reflected signals captured in the first portion of the input to the directional coupler;
calculating a first relative delay between the respective transmitted and reflected signals captured in the first portion;
calculating an amplitude of the respective transmitted and reflected signals captured in the second portion of the input to the directional coupler;
calculating a first relative delay between the respective transmitted and reflected signals captured in the second portion;
aligning the time of the reflected signal captured in the first portion relative to the transmitted signal captured in the first portion; and
aligning the time of the reflected signal captured in the second portion relative to the transmitted signal captured in the second portion.

19. The non-transitory computer readable media including the program instructions of claim 18, wherein calculating (VSWR) comprises:
calculating a power and phase of the reflected signal in the first portion relative to the transmitted signal in the first portion;
calculating a power and phase of the reflected signal in the second portion relative to the transmitted signal in the second portion;
calculating a reflection coefficient on the basis of the reflected power in the second portion and the transmitted power in the first portion; and
calculating the VSWR and phase between the on the basis of an absolute value of the reflection coefficient.

20. The non-transitory computer readable media including the program instructions of claim 18, further comprising storing the VSWR and phase in the memory.

21. An apparatus for self-test measuring voltage standing wave ratio (VSWR) in a transmitter, comprising:
a processor coupled configured to generate a baseband output signal, receive a baseband return signal on the basis of the baseband output signal, and calculate the VSWR on the basis of the output and return signal;
a radio frequency (RF) application specific integrated circuit (ASIC) coupled to the processor configured to output the baseband signal on a transmitted carrier signal and receive a returned carrier signal including the baseband signal;
an antenna coupled to the ASIC to broadcast at least a portion of the baseband signal on the transmitted carrier signal output by the ASIC; and
a switching directional coupler arranged between the ASIC and the antenna to couple at least a portion of the transmitted carrier signal transmitted to the antenna and/or a portion of the transmitted carrier signal reflected from the antenna to a detector port of the ASIC.

22. The apparatus of claim 21, further comprising a power amplifier arranged between the ASIC and the switching directional coupler to amplify the transmitted carrier signal from the ASIC.

23. The apparatus of claim 22, further comprising an RF filter arranged between the ASIC and the power amplifier;

24. The apparatus of claim 22, further comprising a duplexer arranged between the power amplifier and the antenna for transmitting the transmitted carrier signal to the antenna, and for receiving an external (RX) signal from the antenna.

25. The apparatus of claim 24, further comprising a switch arranged between the duplexer and the switching directional coupler for controlling transmission of the transmitted carrier signal to the antenna and reception of the RX signal from the antenna.

26. The apparatus of claim 21, the ASIC further comprising a port configured to receive from the coupler the portion of the transmitted carrier signal transmitted to the antenna and/or a portion of the transmitted carrier signal reflected from the antenna to a detector port of the ASIC.

27. The apparatus of claim 26, further comprising a variable attenuator arranged between the switching directional coupler and receiving port of the ASIC.
